(19) United States
(12) Patent Application Publication
(10) Pub. No.: US 2023/0102603 A1
(43) Pub. Date: Mar. 30, 2023

(54) ADAPTIVE PROXIMITY SENSING DEVICE

(71) Applicant: Luxsentek Microelectronics Corp., New Taipei City (TW)

(72) Inventors: CHEN-HUA HSI, New Taipei City (TW); CHAO-YANG HSIAO, New Taipei City (TW); SHENG-CHENG LEE, New Taipei City (TW); WEN-SHENG LIN, New Taipei City (TW); CHIH-WEI LIN, New Taipei City (TW); YUEH-HUNG HOU, New Taipei City (TW)

(21) Appl. No.: 17/543,452

(22) Filed: Dec. 6, 2021

(30) Foreign Application Priority Data
Sep. 28, 2021 (TW) 110135953

(51) Int. Cl. G01S 17/08; G01S 7/481

(52) U.S. Cl. CPC G01S 17/08; G01S 7/4816

(57) ABSTRACT

The present invention provides an adaptive proximity sensing device, which can adjust the lighting power of a light-emitting element according to the sensed intensity to extends the sensing range. Further, the device can normalize the final sensed intensity to return the normal sensed intensity. Moreover, the uses a linear model of the normal sensed intensity and the distance, so the device can quickly determine the distance of the object.

### BACKGROUND OF THE INVENTION

### 1. Field of the Invention

The present invention relates to an adaptive proximity sensing device, and particularly that can adjust the lighting time or power to suit different conditions.

### 2. Description of the Prior Art

Proximity sensing device usually uses one or more infrared light-emitting elements to emit infrared ray to an external object, a light receiving element to collect the reflected light and converted into an electrical signal, and a control unit to interpret the electrical signal to achieve special function. For example, a distance sensor, which can measure the distance, uses a light emitting diode (LED) or a vertical cavity surface emitting laser (VCSEL) as the light emitting element, and a photodiode as the photosensitive element.

Generally, the distance between the object and the proximity sensing device varies with time. At fixed illuminating power, the object may be too close so that the proximity sensing device fails in sensing the distance because the intensity of the reflected light runs out of the upper limit.

Conversely, the object may be too far and the intensity of the reflected light has reached zero (the lower limit) to fail the proximity sensing device.

### SUMMARY OF THE INVENTION

An adaptive proximity sensing device is proposed here. The proximity sensing device automatically adjusts the lighting time or duty in a pulse (or called pulse width) of the light-emitting element according to the current distance of the object to have a suit lighting power. The lighting power can avoid intensity of the reflected light to run out of its limitations, so the proximity sensing device can maintain the function.

An adaptive proximity sensing device, comprising:

a light-emitting element configured to emit a detection light with a lighting power, wherein the light-emitting element is driven by a driver, and the driver uses a pulse width or a pulse intensity to set the lighting power;
a photosensitive element configured to convert a reflected light of an object into a light-sensing analog signal;
an analog-to-digital converter (ADC) configured to convert the light-sensing analog signal to a light-sensing digital signal; and
a digital processor configured to control the driver to adjust the lighting power according to a sensed intensity calculated by the light-sensing digital signal, wherein the digital processor decreases the lighting power if the sensed intensity is higher than a high threshold or increases the lighting power if the sensed intensity is lower than a low threshold till the lighting power falls in between the low threshold and the high threshold to get a modulated intensity.

A distance sensor, comprising

a light-emitting element configured to emit a detection light with a lighting power, wherein the light-emitting element is driven by a driver, and the driver uses a pulse width or a pulse intensity to set the lighting power;
a photosensitive element configured to convert a reflected light of an object into a light-sensing analog signal;
an analog-to-digital converter (ADC) configured to convert the light-sensing analog signal to a light-sensing digital signal; and a digital processor configured to control the driver to adjust the lighting power according to a sensed intensity calculated by the light-sensing digital signal, wherein the digital processor
adjusts the lighting power by an adjustment ratio to get a modulated intensity if the sensed intensity is higher than a high threshold or lower than a low threshold, wherein the adjustment ratio is a ratio of a default modulated intensity to the sensed intensity, and the default modulated intensity is between the high threshold and the low threshold,
calculates a normal intensity according to the adjustment ratio and the modulated intensity, and
determines a distance of the object according the normal intensity.

### BRIEF DESCRIPTION OF THE DRAWINGS

FIG. 1 is a schematic diagram to show the basic architecture of the proximity sensing device of the present invention.

FIG. 2 is a flowchart of adaptive adjustment of the proximity sensing device of the present invention.

### DESCRIPTION OF THE PREFERRED EMBODIMENTS

Below embodiments accompanied with drawings are used to explain the spirit of this invention to have better understanding for the person in this art, not used to limit the scope of this invention, which is defined by the claims. The applicant emphasizes the element quantity and size are schematic only. Moreover, some parts might be omitted to skeletally represent this invention for conciseness.

The adaptive proximity sensing device of the present invention can automatically adjust the lighting power via the pulse width or pulse intensity of the light-emitting element according to the distance between the object and the adaptive proximity sensing device. A conventional devise fails its function if the sensed intensity is too high or too low, so an adaptive device is proposed here. The adaptive device decreases its lighting power when the sensed intensity is too high, and it increases the light power when the sensed intensity is too low. The adjustable lighting power modulates the sensed intensity to falls in between a high threshold and a low threshold, so the adaptive can extends its sensing range. In general, the lighting can be adjusted by changing its pulse width or pulse intensity. Because the sensed intensity has been modulated, called modulated intensity here, and the modulated intensity should be normalized to return a normal sensed intensity. The adaptive proximity sensing device can be used as a distance sensor. For example, a linear model, i.e. the relationship of the sensed intensity and the distance of the object is linear, so we can get the distance from the sensed intensity quickly. As a result, the adaptive proximity sensing device can sense a closer or a farer object.

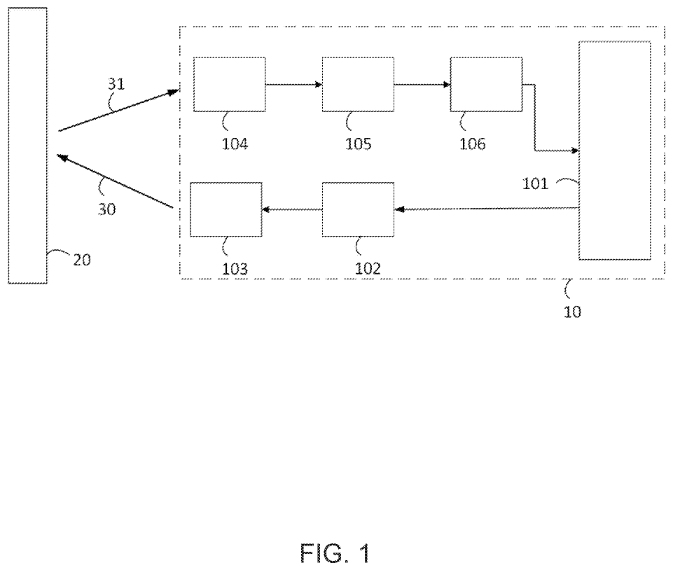

FIG. 1 shows the component layout scheme of an adaptive proximity sensing device of the present invention. The adaptive proximity sensing device 10 comprises a digital processor 101, a light-emitting module, a photosensitive element 104, a DC offset subtractor 105, and an analog-to-digital converter (ADC) 106. The light-emitting module comprises a light-emitting element 103 and a driver 102.

In other embodiments, a DAC (not shown) coupled between the digital processor 101 and the driver 102 is used to convert the digital control signal into an analog control signal. In another embodiment, the digital processor 101 directly outputs an analog control signal. The digital control signal uses the pulse width or the pulse intensity to adjust the lighting power, so the analog control signal is corresponding to the lighting power.

The driver 102 is coupled between the light-emitting element 103 and the digital processor 101. The driver 102 receives the analog control signal to drive the light-emitting element 103 to emit a detection light 30.

The reflected light 31, i.e. the reflection of the detection light 30 on an object 20, is received by the photosensitive element 104 and then converted to an analog signal. In one embodiment, a DC offset subtractor 105 is coupled between the photosensitive element 104 and the ADC 106. The DC offset subtractor 105 is used to amplify the analog signal. The ADC 106 converts the analog signal into a digital signal, and the digital processor 101 used the digital signal to deduce a sensed intensity.

When the reflected signal is too large or too small, the sensed intensity reaches the maximum or minimum and the sensed result cannot be interpreted. The adaptive proximity sensing device decreases the lighting power when the sensed intensity is larger than a high threshold or increases the lighting power when the sensed intensity is smaller than a low threshold. As a result, the sensed intensity converges into between the high threshold and the low threshold, and the sensing device can still work. The sensed intensity has been modulated by the lighting power, so the modulated sensed intensity should be normalized to return to a normal sensed intensity.

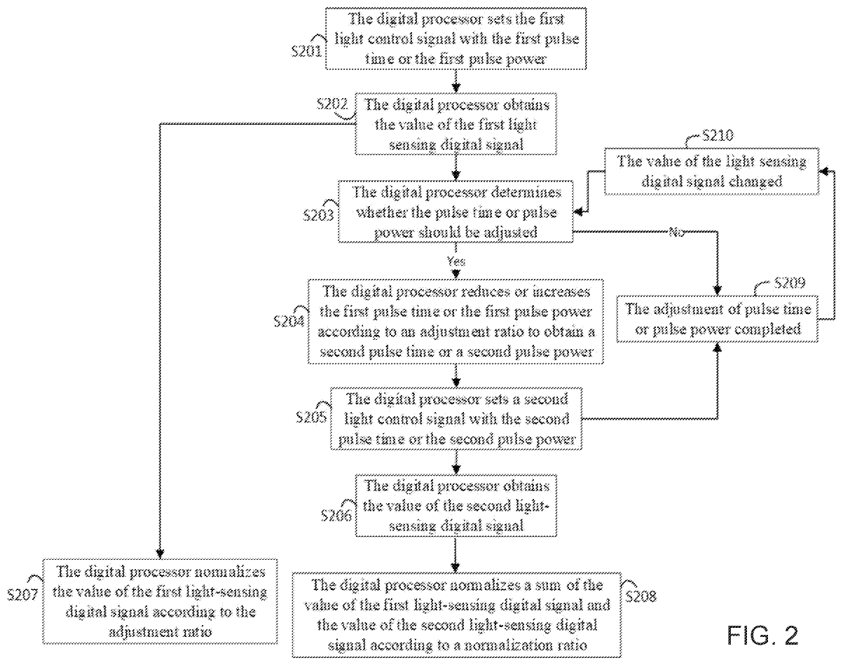

FIG. 2 shows the modulating flow of the adaptive proximity sensing device of the present invention. The adaptive proximity sensing device initializes the lighting power, sets the adjustment ratio as 1, and then starts sensing. The photosensitive element senses and converts the reflected light to a digital signal, and then the digital processor to calculates the sensed intensity, shown as S201˜S202.

The digital processor checks the sensed intensity and determines to change the pulse width or pulse intensity, shown as S203. If the sensed intensity is higher than the high threshold or lower than a low threshold, the change the lighting power by an adjustment ratio, shown as S204˜S205. The control is marked as a first light control signal before modulation and a second light control signal after modulation in the FIG. 2. The high threshold and the low threshold are respectively 70%˜90% and 10%˜30% of the maximum sensed intensity. The sensed intensity falls in between the high threshold and the low threshold to complete the modulation loop and the final sensed intensity is called the modulated intensity herein, shown as S209.

If the digital processor judges that the lighting power should be adjusted, and the adjustment ratio can be derived by the following formula (1), and that is a ratio of a default modulated intensity to the sensed intensity. The default modulated intensity is smaller than the high threshold and larger than the low threshold. The modulating light power is derived by the following formula (2):

Adjustment ratio=(default modulated intensity)/(current sensed intensity) (1)

Modulated lighting power=(adjustment ratio)*(current lighting power) (2)

The lighting power is shown as S210. The object distance may vary and then enter the modulation loop again, and the adjustment ratio varies with the variable distance. It is obvious that the adjustment ratio is smaller than 1 to reduce the lighting power if the sensed intensity is larger than the high threshold, and the adjustment ratio is larger than 1 to boost the lighting power if the sensed intensity is smaller than the low threshold.

The sensed intensity is modulated by the light power and the sensed falls into between the low threshold and the high threshold, called a modulated intensity. After the modulation loop, the sensed intensity reaches the default modulated intensity. The modulated intensity may be normalized by the adjustment ratio to return the normal sensed intensity to get a correct interpretation, shown as step S205 or S207. The modulated intensity is normalized by the following formula (3).

Normal intensity=(normalization ratio)*(sensed intensity) (3)

The normalization ratio generally is reverse proportional to the adjustment ratio.

If the sensed intensity falls in between the high threshold and the low threshold, the lighting power is not needed to change. In this case, the adjustment ratio is 1, the modulated intensity is the sensed intensity, and the normal intensity is the sensed intensity, shown as step S207.

If the sensed is out of between the high threshold and the low threshold but in the maximum and the minimum of the sensed intensity, the iteration number of the modulation loop is one. In this case, the adjustment ratio is determined by formula (1), and the normalization ratio is the reverse of the adjustment ratio, shown as step S205, S206 and S208. The lighting power is modulated one time and then the modulated intensity reaches the default modulated intensity, so the normal intensity is (modulated intensity)/(adjustment ratio).

If the sensed intensity is out of the maximum or minimum, iteration number of the modulation will more than 2 times till the sensed intensity falls in between the low threshold and the high threshold. The adjustment ratio is fixed at K, where K is equal to (default modulated intensity)/(the maximum or minimum) when the sensed intensity is larger/smaller than the maximum/minimum. Finally, the sensed intensity is modulated to the modulated intensity, which is in between the low threshold and the high threshold. In this case, the normalization ratio is reverse proportional to K⁽ⁿ⁻¹⁾, where n is the iteration number of the modulation loop. The normal intensity is normalization ratio multiply the modulated intensity.

The proximity sensing device extends the sensible range by using the adjustable lighting power and normalization technology. It can measure the object distance at extreme close or far condition.

What is claimed is:

1. An adaptive proximity sensing device, comprising:
a light-emitting element configured to emit a detection light with a lighting power, wherein the light-emitting element is driven by a driver, and the driver uses a pulse width or a pulse intensity to set the lighting power;
a photosensitive element configured to convert a reflected light of an object into a light-sensing analog signal;
an analog-to-digital converter (ADC) configured to convert the light-sensing analog signal to a light-sensing digital signal; and
a digital processor configured to control the driver to adjust the lighting power according to a sensed intensity calculated by the light-sensing digital signal, wherein the digital processor decreases the lighting power if the sensed intensity is higher than a high threshold or increases the lighting power if the sensed intensity is lower than a low threshold till the lighting power falls in between the low threshold and the high threshold to get a modulated intensity.

2. The adaptive proximity sensing device according to claim 1, further comprising a DC offset subtractor, between the photosensitive element and the ADC, configured to amplify the light-sensing analog signal.

3. The adaptive proximity sensing device according to claim 1, wherein the digital processor adjusts the lighting power by an adjustment ratio that is a ratio of a default modulated intensity to the sensed intensity, and the default modulated intensity is between the high threshold and the low threshold.

4. The adaptive proximity sensing device according to claim 1, wherein the high threshold and the low threshold are respectively to estimate the sensed intensity.

5. The adaptive proximity sensing device according to claim 1, wherein the digital processor normalizes the modulated intensity according to the adjustment ratio to calculate a normal sensed intensity.

6. An adaptive proximity sensing device, comprising:
a light-emitting element configured to emit a detection light with a lighting power, wherein the light-emitting element is driven by a driver, and the driver uses a pulse width or a pulse intensity to set the lighting power;
a photosensitive element configured to convert a reflected light of an object into a light-sensing analog signal;
an analog-to-digital converter (ADC) configured to convert the light-sensing analog signal to a light-sensing digital signal; and
a digital processor configured to control the driver to adjust the lighting power according to a sensed intensity calculated by the light-sensing digital signal, wherein the digital processor adjusts the lighting power by an adjustment ratio to get a modulated intensity if the sensed intensity is higher than a high threshold or lower than a low threshold, and the adjustment ratio is a ratio of a default modulated intensity to the sensed intensity, and the default modulated intensity is between the high threshold and the low threshold.

7. The adaptive proximity sensing device according to claim 6, wherein the high threshold and the low threshold are respectively to estimate the sensed intensity.

8. The adaptive proximity sensing device according to claim 6, wherein the digital processor adjusts the lighting power by multiplying the adjustment ratio till the sensed intensity falls in between the between the high threshold and the low threshold to get the modulated intensity.

9. The adaptive proximity sensing device according to claim 1, wherein the digital processor normalizes the modulated intensity according to the adjustment ratio to calculate a normal sensed intensity.

10. A distance sensor, comprising
a light-emitting element configured to emit a detection light with a lighting power, wherein the light-emitting element is driven by a driver, and the driver uses a pulse width or a pulse intensity to set the lighting power;
a photosensitive element configured to convert a reflected light of an object into a light-sensing analog signal;
an analog-to-digital converter (ADC) configured to convert the light-sensing analog signal to a light-sensing digital signal; and
a digital processor configured to control the driver to adjust the lighting power according to a sensed intensity calculated by the light-sensing digital signal, wherein the digital processor
adjusts the lighting power by an adjustment ratio to get a modulated intensity if the sensed intensity is higher than a high threshold or lower than a low threshold, wherein the adjustment ratio is a ratio of a default modulated intensity to the sensed intensity, and the default modulated intensity is between the high threshold and the low threshold,
calculates a normal intensity according to the adjustment ratio and the modulated intensity, and
determines a distance of the object according the normal intensity.

11. The distance sensor according to claim 10, wherein the distance and the normal intensity is linear.
